(19) United States
(12) Patent Application Publication
(10) Pub. No.: US 2026/0097511 A1
(43) Pub. Date: Apr. 9, 2026

(54) Self-healing Robot for kitchen environment

(71) Applicant: Miso Robotics, Inc., Pasadena, CA (US)

(72) Inventors: Bachir Kharraja, Irvine, CA (US); Zachary Zweig Vinegar, Pasadena, CA (US); Yusuke Kojitani, Pasadena, CA (US); Ibrahim Helal, Pasadena, CA (US); Jayasurya Sevalur Mahendran, Pasadena, CA (US)

(21) Appl. No.: 19/344,082

(22) Filed: Sep. 29, 2025

Related U.S. Application Data
(60) Provisional application No. 63/703,953, filed on Oct. 5, 2024.
(60) Provisional application No. 63/710,642, filed on Oct. 23, 2024.

(51) Int. Cl. B25J 9/16; A47J 37/12; A47J 44/00; B25J 11/00

(52) U.S. Cl. CPC B25J 9/1692; A47J 37/1219; A47J 37/1228; A47J 37/1266; A47J 37/1295; A47J 44/00; B25J 9/1674; B25J 11/0045

(57) ABSTRACT

An automated food preparation system includes an enclosure defining a robotic workspace, a robotic arm and a plurality of functional stations for dispensing raw food to a bin, transferring the raw food from the bin to a fry basket, frying the raw food, and transferring the cooked food to a receiving pan. The system is programmed and operable to monitor its health, and to adjust operating parameters in order to compensate for detected conditions outside of a predetermined acceptable range. Related methods are described.

### CROSS-REFERENCE TO RELATED APPLICATIONS

This claims priority to application number 63/710,642, filed Oct. 23, 2024, and entitled “SELF-HEALING ROBOT FOR KITCHEN ENVIRONMENT”; and to application number 63/703,953, filed Oct. 5, 2024, and entitled “AUTOMATED FOOD FRYING SYSTEM” each of which is incorporated herein by reference in its entirety for all purposes.

### BACKGROUND OF THE INVENTION

### 1. Field of the Invention

This invention relates to food preparation systems, and more particularly, to automated food preparation systems adapted to provide freshly fried food items with minimal to no human interaction.

### 2. Description of Related Art

Robotic kitchen systems are designed to operate automatically continuously, up to 24 hours a day. In a restaurant environment for frying food, for example, a robotic arm may be programmed to dip a basket in oil. Repeatedly dipping the basket in oil can cause the arm or basket to bend over time. The bend or wear can increase over time, leading to a few problems, including permanent damage to the system components. These issues necessitate frequent manual interventions, reducing operational uptime and increasing maintenance costs.

Accordingly, there is a need for improved robotic systems that minimize component wear and are preferably fully automated.

### SUMMARY OF THE INVENTION

In embodiments of the invention, an automated food preparation system for cooking raw food comprises: an enclosure defining a robot workspace; a robotic arm arranged within the robot workspace; a plurality of functional stations, and a computer system programmed and operable to monitor the health of the functional stations.

In embodiments of the invention, the functional stations comprise one or more of the following: a dispensing station for dispensing raw food into a basin; a food transfer station operable to lift the basin, and to transfer the raw food from the basin to a fry basket held by the robotic arm; and a fry station arranged within the enclosure and comprising at least one fryer for frying the fry basket of raw food into cooked food.

In embodiments of the invention, the system includes a computer system programmed to: control the plurality of functional stations and robotic arm to dispense the raw food to the basin, transfer the raw food to the fry basket, robotically move the fry basket along a route into a fryer, fry the raw food, transfer the cooked food to an egress area for transferring the cooked food from inside the enclosure to outside the enclosure; and monitor the health of the functional stations and robotic arm by obtaining real-time sensor data from each of the stations during cooking. The real-time sensor data is analyzed by the computer system for an abnormal condition based on comparing the real-time sensor data and baseline sensor data. The computer system computes an adjustment and modifies the functional station or robotic arm based on the computed adjustment.

In embodiments of the invention, the system further comprises an auto-drawer station arranged within the enclosure, comprising at least one drawer movable from a retracted first configuration within the enclosure to an extended second configuration through an ingress window outside of the enclosure, and wherein the at least one drawer and ingress window are arranged, sized and operable to transfer a fry basket between a human outside of the enclosure and the robotic arm inside of the enclosure without the human or robotic arm penetrating a boundary defined by the enclosure.

In embodiments of the invention, a method for automatically preparing raw food comprises: automatically dispensing a target amount of raw food into a basin; lifting by a motor-driven elevator the basin of raw food above a fry basket; dumping the raw food from the basin into the fry basket; robotically moving the fry basket along a predetermined route into a fryer; cooking the raw food in the fryer; robotically transferring the cooked food to an egress area for transferring the cooked food from inside the enclosure to outside the enclosure; continuously obtaining real-time sensor data during each of the dispensing, lifting, robotically moving, and robotically transferring steps; and analyzing each step for an abnormal condition based on comparing the real-time sensor data and baseline sensor data.

In embodiments of the invention, if one of the steps has an abnormal condition, then the method further computes an adjustment to the offending step based on the analyzing step; and modifies the offending step based on the computed adjustment.

In embodiments of the invention, the sensor data comprises at least one of robotic arm torque, robotic arm position, elevator motor current, camera parameters, and the weight of the raw food dispensed into the basin.

In embodiments of the invention, the food transfer station comprises an elevator to move the basin between a first elevation for receiving the raw food from the dispensing station to a second elevation higher than the first elevation for dumping the raw food into the fry basket.

In embodiments of the invention, the real-time sensor data comprises current data of a motor for moving the elevator, and the current for the elevator is modified.

In embodiments of the invention, the real-time sensor data comprises weight data of the raw food dispensed into the basin by the dispenser, and the dispensing controls are modified.

In embodiments of the invention, the real-time sensor data comprises torque data of the robotic arm, and the route of the robotic arm is modified.

In embodiments of the invention, the real-time sensor data comprises position data of the robotic arm, and the route of the robotic arm is modified.

In embodiments of the invention, the real-time sensor data comprises image data for a camera, and camera parameters are modified.

In embodiments of the invention, the computer system is programmed to verify the abnormal condition is absent during cooking after the modification has been made.

The description, objects and advantages of the present invention will become apparent from the detailed description to follow, together with the accompanying drawings.

### BRIEF DESCRIPTION OF THE DRAWINGS

FIG. 1 illustrates a left-side top isometric view of a robotic food preparation system in accordance with an embodiment of the invention;

FIG. 2 is a front view of the robotic food preparation system shown in FIG. 1;

FIG. 3 is a top view of the robotic food preparation system shown in FIG. 1;

FIG. 4 is a flow chart of an overview of method for mitigating wear to a robotic food preparation system in accordance with an embodiment of the invention;

FIG. 5 is flow chart of a method for force-tuning a robotic food preparation system in accordance with embodiments of the invention;

FIG. 6 is flow chart of a method for deformation reduction in a robotic food preparation system in accordance with embodiments of the invention;

FIG. 7 is flow chart of a method for food dispensing adjustment in a robotic food preparation system in accordance with embodiments of the invention;

FIG. 8 is flow chart of a method for elevator motor optimization in a robotic food preparation system in accordance with embodiments of the invention;

FIG. 9 is flow chart of a method for camera quality monitoring and calibration in a robotic food preparation system in accordance with embodiments of the invention; and

FIG. 10 is a block diagram of a robotic food preparation system in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### APPARATUS OVERVIEW

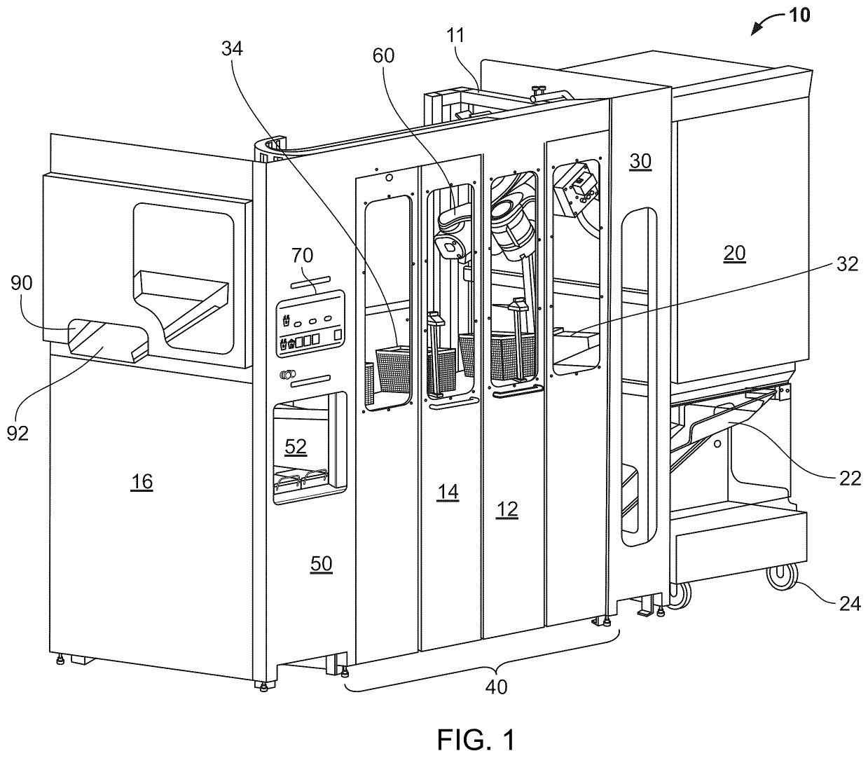

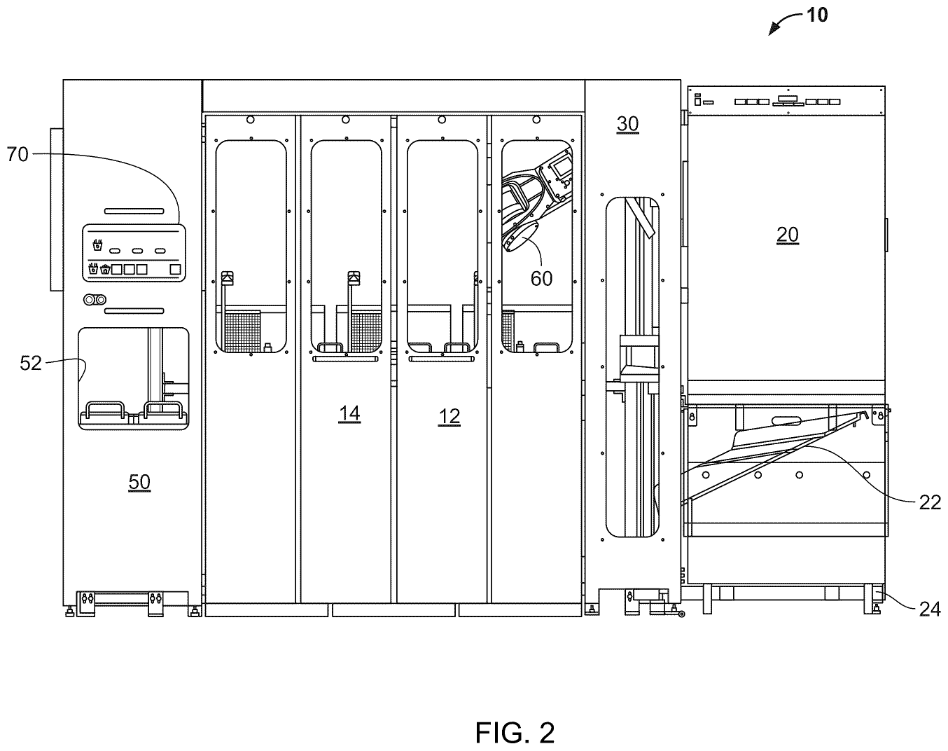

FIGS. 1-3 show various views of an automated food preparation system 10 for frying raw food in accordance with an embodiment of the invention. Non-limiting examples of types of raw foods for frying include tortilla chips, fries, popcorn chicken, chicken nuggets or wings, fish sticks, and vegetables.

The system 10 is shown having several functional stations or modules including a refrigerated food dispenser/hopper 20, a raw food transfer station 30 (including elevator basin 32), fryer station 40 (including fryers 42, 44, 46), fry baskets 34, auto-basket station 50 (including raw food ingress window 52), robotic arm 60, touchscreen user interface 70, and cooked food egress window 90 (including chute 92), each of which is discussed herein.

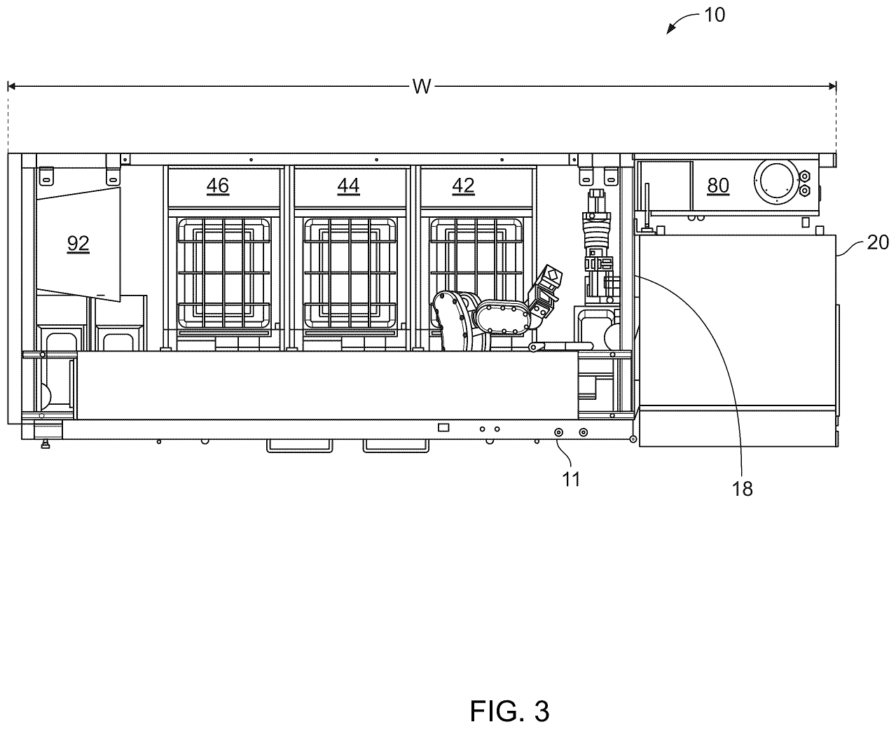

Functional stations 30, 40, and 50 are shown arranged within an enclosure, thereby defining a robotic workspace that separates the robotic arm 60 from a human or operator. The enclosed or walled robotic workspace is shown having a frame 11, front doors 12, 14, left side wall 16, and right-side wall 18. With reference to FIG. 3, the dispenser 20 is located in a square space defined by the right-side wall 18 of the enclosure and the electronic box assembly 80. Optionally, a sensor (e.g., a magnetic proximity sensor) is arranged on the frame or electronic box assembly to confirm proper location of the dispenser 20 relative to the frame and enclosed robotic workspace. Optionally, the dispenser 20 includes castors 24 for adjusting its location relative to the robotic enclosure.

Additionally, electronic and computer components, discussed herein, can be enclosed within an electronics housing or enclosure 80 and mounted to the frame 11 for controlling the various stations and collecting and storing data.

One or more sensors and cameras can be arranged with the enclosure and stations. The image data is sent to the computer and electronics. As discussed further herein, the sensed data and images can be used to detect and track various objects including, e.g., amount of food dispensed, elevator position, basket location, state of an order, robotic workspace (e.g., door or drawer) open, and component wear, as discussed further herein.

An example of a robotic food preparation system including the various functional stations is described in provisional patent application number 63/703,953, filed Oct. 5, 2024, entitled “AUTOMATED FOOD FRYING SYSTEM”, which is incorporated herein by reference in its entirety for all purposes.

### METHOD OVERVIEW

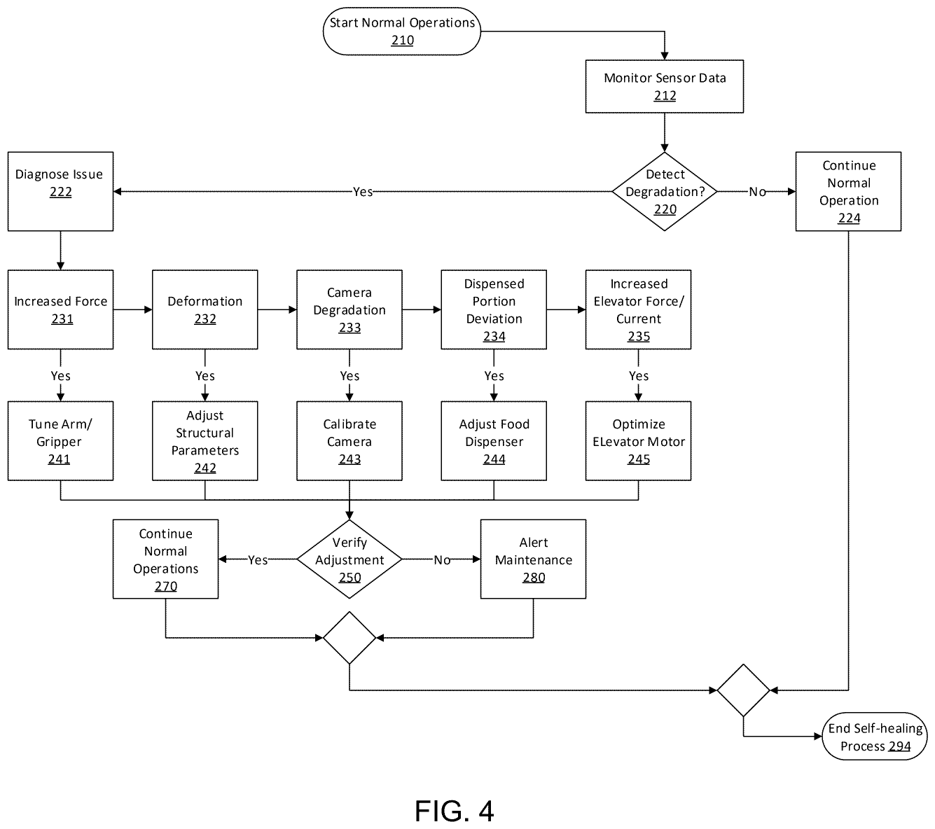

FIG. 4 shows a flow chart of a method 200 for monitoring wear or health of a robotic food preparation system in accordance with an embodiment of the invention.

Step 210 commences normal operation. In embodiments, a user manually begins the process using a computing device such as a tablet or another user interface. In embodiments, the food preparation process is commenced automatically to cook a food item based on an order.

For example, when an order for French fries is received, the system may automatically commence the order, requiring several different functional stations to collectively operate to prepare and cook the raw food.

### FOOD DISPENSER

In embodiments, and with reference to FIGS. 1-3, a dispenser station 20 dispenses a predetermined amount of raw food into a bin. An example of a suitable refrigerated food dispenser is the RAM 280, manufactured by Taylor UK (Ipswich, England). In embodiments, the dispenser is operable to be programmed to dispense a predetermined (or target) amount of food.

### ELEVATOR STATION

A motorized elevator station 30 automatically lifts the bin above a fry basket, and dumps the raw food into the fry basket 34. The elevator station can include a motor and linear guide assembly for moving the bin along the guide. In embodiments, the bin is operable to dump the raw food to the fry basket by, e.g., (a) tilting or (b) opening a trap door, thereby releasing the contents. An example of an elevator station is described in provisional patent application number 63/703,953, filed Oct. 5, 2024, entitled “AUTOMATED FOOD FRYING SYSTEM”, which is incorporated herein by reference in its entirety for all purposes.

### ROBOTIC ARM ASSEMBLY

A robotic arm assembly 60 is operable to grip and move the fry basket into the fryer 42, 44, 46 for cooking.

After the food is cooked, the robotic arm removes the fry basket from the fryer and dumps the cooked food onto a chute 92. The chute gravity feeds the cooked food into a hot hold for pickup.

An exemplary robotic arm 60 has 6-axis motion (or degrees of freedom) such as the Yaskawa GP4 Arm manufactured by Yaskawa America, Inc., Motoman Robotics Division (Miamisburg, OH).

Additionally, in embodiments, the robotic arm assembly includes a gripper for gripping a handle of the basket 34, or for gripping an adapter fastened to the basket or another utensil. In embodiments, the gripper is a clamp-type assembly. An exemplary gripper is Zimmer Group GEP2016IO-05-B Gripper manufactured by Zimmer Group US Inc. (Hickory, NC). Examples of end effector clamping assemblies, holds and fry baskets are described in: U.S. Pat. No. 11,167,421, filed Aug. 7, 2019, entitled “ROBOTIC KITCHEN ASSISTANT INCLUDING UNIVERSAL UTENSIL GRIPPING ASSEMBLY”; U.S. Pat. No. 11,192,258, filed Aug. 7, 2019, entitled “ROBOTIC KITCHEN ASSISTANT FOR FRYING INCLUDING AGITATOR ASSEMBLY FOR SHAKING UTENSIL”, and US Publication No. 20230292957, filed Jan. 31, 2023, entitled “AUTOMATED FOOD FRYING SYSTEM”, each of which is incorporated herein by reference in its entirety.

In embodiments, the robotic arm and gripper execute a predetermined route. The 3D coordinates of the predetermined routes can be manually executed and saved. In embodiments, after the gripper clamps onto the fry basket, the robotic arm moves the fry basket from the elevator into the fryer along a predetermined 3D route according to a predetermined velocity. A library of predetermined routes can be stored for the robotic arm for each type of order, or activity (e.g., cleaning, calibration, frying, dumping, home, etc.).

### AUTO-BASKET STATION

Optionally, an auto-basket station 50 is operable to accept baskets and alternative types of raw food for cooking.

Indeed, a wide variety of food preparation actions can be performed by the robotic food preparation system. The invention is not intended to be limited to any particular configuration except as recited by the claims.

With reference again to FIG. 4, step 212 states to monitor sensor data. As described herein, components or stations of the system include various sensors and cameras. Data from the sensors and cameras is collected for evaluation. In embodiments, the monitoring is ongoing and performed in real-time, continuously or periodically, e.g., hourly, daily, weekly, etc. In embodiments, the self-healing process is ongoing and perpetually running in parallel with normal operations of the robotic food preparation system.

Step 220 states to detect degradation. In embodiments, acceptable threshold ranges are stored for the sensor data. If the collected data falls within these acceptable or normal threshold ranges, the process assumes the wear is acceptable and that there is little or no degradation. The process moves to step 224, to continue normal operation.

If, on the other hand, any of the collected data from the sensors falls outside of the threshold ranges, the process assumes there is an issue and advances to step 222 to diagnose the issue.

Step 222 states to diagnose the issue. In embodiments, step 222 comprises evaluating the sensor data for a number of offending conditions (e.g., increased force 231, deformation 232, camera degradation 233, dispenser portion deviation 234, and increased elevator force/current 235). If an offending (namely, abnormal or errant) condition is detected, the method adjusts the offending condition including, e.g., tuning arm/gripper 241, adjusting structural parameters 242, calibrating camera 243, adjusting food dispenser 244, and optimizing elevator motor 245, each of which is discussed further herein.

Step 250 states to verify adjustment. In embodiments, after the condition is adjusted, the system verifies the adjustment cured the errant condition. In embodiments, this step is performed by running the component or station (e.g., the dispenser, elevator, robotic arm or cameras), and confirming by the sensor data that a degradation issue is not detected.

If the adjustment from step 250 was successful, the process moves to step 270 to continue normal operations. If the adjustment from step 250 was not successful, the process moves to step 280, and an alert message is sent to the user or maintenance to manually check the system. An alert message may be delivered via SMS, audio, or displayed on the user interface as the case may be.

Step 294 states to end self-healing process. In embodiments, the process is terminated. In other embodiments, the process is on-going and continues, optionally, in real-time during use of the robotic food preparation system.

### FORCE TUNING

During normal cooking operations, there are expected levels of force on components of the robotic arm. For example, and with reference to FIGS. 1-3, a robotic arm 60 is shown moving the basket 34 into the oil reservoir of fryer 46.

Over time, due to physical deformation or misalignments, changes in these forces can occur. For instance, if a fryer basket 34 is being dipped and begins scraping against the side of the fryer 46, this would result in extra force being detected in the y-direction by motors in the arm. It is desirable to detect this extra force, and mitigate any damages arising from the extra force on the equipment.

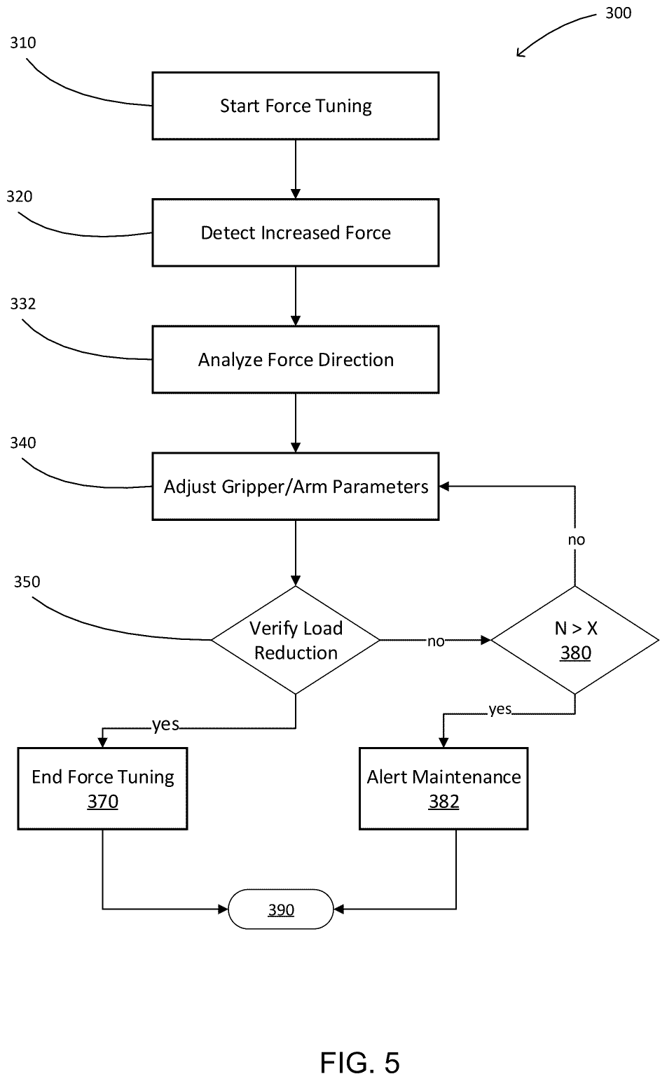

FIG. 5 shows a flow chart of a method 300 force tuning the robotic food preparation system in accordance with an embodiment of the invention.

Step 310 commences the process. In embodiments, a user manually begins the process using a computing device such as a tablet or another user interface. In embodiments, the self-healing process is ongoing and programmed to automatically be performed in real-time, continuously or periodically, e.g., hourly, daily, weekly, etc. In embodiments, the self-healing process is ongoing and perpetually running in parallel with the normal operations of the robotic system.

Step 320 states to detect increased force. Torque sensors in the gripper and arm motors continuously monitor the force exerted as the robotic arm executes its route. In embodiments, the recorded units are in Newton-meters (Nm), which measure the torque being applied. In embodiments, acceptable torque force threshold ranges are recorded during an installation. If the collected data falls within these acceptable or normal threshold ranges, the process assumes the force is acceptable and that there is little or no degradation. The process continues according to normal operation.

If, on the other hand, the detected torque/force falls outside of the threshold ranges, the process assumes there is an issue and advances to step 332 to analyze the force.

Step 332 states to analyze force direction. In embodiments, the system analyzes the direction of this additional force. For instance, if a fryer basket 34 is being dipped and begins scraping against the side of the fryer 46, this would result in extra force being detected in the y-direction by motors in the arm.

Step 340 states to adjust gripper/arm parameters. In embodiments, the system adjusts the predetermined route of the robot arm 60, such as its trajectory or angle, to minimize this offending force. For example, the robot could slightly reposition (in the opposite direction to the detected extra force) where it dips the fry basket, shifting the fry basket to the side of the location causing the extra force, thereby reducing strain and wear on the arm components, and basket, over time. In embodiments, a route adjustment may include adjusting the y-coordinate at time (t) by 0.5 to 2 inches, while keeping the x and z coordinates, and velocity same.

Step 350 states to verify load reduction. In embodiments, this step is performed by running the component or station (e.g., the robotic arm), and confirming by the sensor data that an increased force is not detected.

If the adjustment from step 350 was successful, the process moves to step 370 to end the force-tuning phase and continue normal operations.

If the adjustment from step 350 was not successful, the process returns to step 340 for further adjustment (namely, re-adjustment). Optionally, the parameter is modified by another 5-10%. Re-adjustment and verification can be repeated up to a fixed number of cycles (e.g., N=5) after which the process moves to step 382 and an alert message is sent to the user or maintenance to manually check the system. An alert message 382 may be delivered via SMS, audio, or displayed on the user interface as the case may be.

Step 390 ends the force-tuning process. In embodiments, the force tuning is ended. However, in embodiments, the detecting is ongoing or continuous with normal operations of the robotic system.

### DEFORMATION

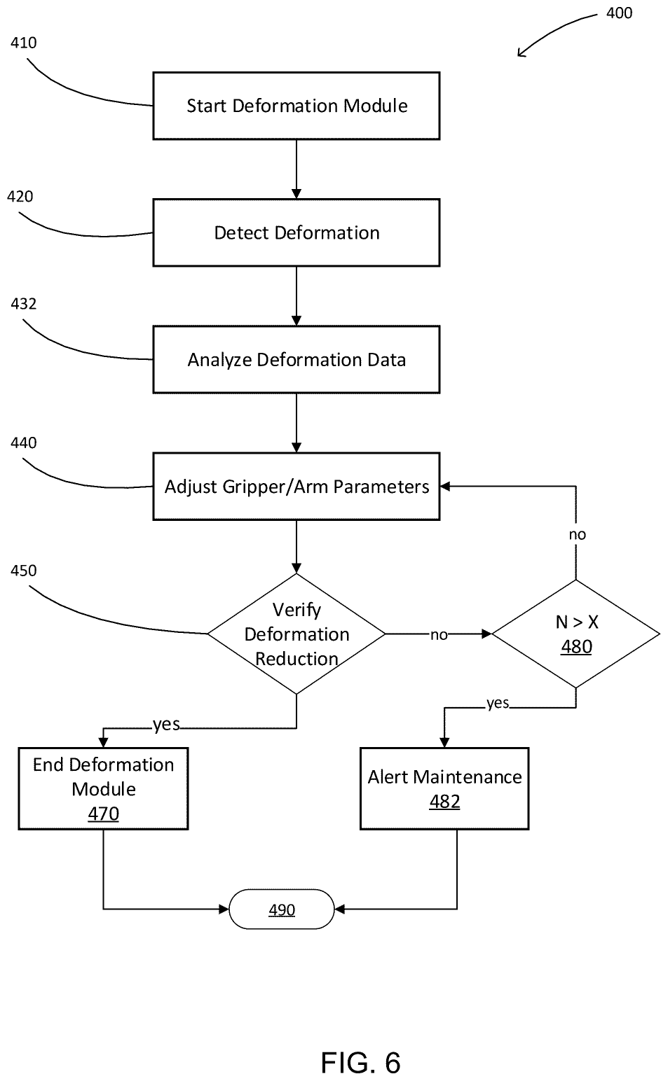

FIG. 6 shows a flow chart of a method 400 for deformation adjustment of the robotic food preparation system in accordance with an embodiment of the invention.

Step 410 commences the process. In embodiments, a user manually begins the process using a computing device such as a tablet or another user interface. In embodiments, the self-healing process is ongoing and programmed to automatically be performed in real-time, continuously or periodically, e.g., hourly, daily, weekly, etc. In embodiments, the self-healing process is ongoing and perpetually running in parallel with normal operations of the robotic system.

Step 420 states to detect deformation. In embodiments, deformation is detected using deformation detectors to measure changes in the robot's frame and components.

For example, sensors in the robotic arm and grippers detect positional changes, measured in millimeters (mm).

Current readings are compared to baseline values established during a fresh installation. Changes in the current readings from the baseline values indicate possible deformation or misalignment.

If the collected data falls within acceptable or normal threshold ranges, the process assumes the deformation is acceptable and that there is little or no deformation. The process continues according to normal operation.

If, on the other hand, the detected deformation falls outside of the baseline ranges, the process assumes there is an issue and advances to step 432 to analyze the deformation.

Step 432 states to analyze deformation. In embodiments, the system analyzes the amount of deformation (e.g., Y-direction of this additional distance) observed along the predetermined path. For instance, if a fryer basket 34 is being dipped and begins scraping against the side of the fryer 46, this would result in displacement in the y-direction. Changes in these position readings indicate possible deformation or misalignment.

Step 440 states to adjust gripper/arm parameters. In embodiments, adjustments are computed and made by updating the robot arm's route or trajectory to reduce observed displacements. For instance, if the observed displacement is 5 mm in the Y-direction, the robot's path can be recalibrated to counteract this shift by adjusting position coordinates within ±5 mm range, while recalibrating operational velocities as necessary to maintain fluid movement. In embodiments, the robotic path is recalibrated to alleviate stress on the moving components, thus aiming to reduce wear and prolong the lifespan of the components involved.

Step 450 states to verify load reduction. In embodiments, this step is performed by running the component or station (e.g., the robotic arm), and confirming by the sensor data that deformation is not detected.

If the adjustment from step 450 was successful, the process moves to step 470 to end the deformation phase and continue normal operations.

If the adjustment from step 450 was not successful, the process returns to step 440 for further adjustment (namely, re-adjustment). Optionally, the parameter is modified by another 5-10%. Re-adjustment and verification can be repeated up to a fixed number of cycles (e.g., N=5) after which the process moves to step 482, and an alert message is sent to the user or maintenance to manually check the system. An alert message may be delivered via SMS, audio, or displayed on the user interface as the case may be.

Step 490 ends the deformation adjustment process. In embodiments, the adjustment is ended. However, in embodiments, the detecting is ongoing or continuous with normal operations of the robotic system.

### FOOD DISPENSER ADJUSTMENT

In embodiments, and with reference again to FIGS. 1-3, a food preparation comprises a food dispenser 20. It can be controlled by the electronics module 80 to dispense a predetermined amount of raw food into a food bin. As stated above, an example of a suitable refrigerated food dispenser is the RAM 280, manufactured by Taylor UK (Ipswich, England). As described herein, it is desirable to monitor the accuracy and health of the dispenser in order to ensure the proper amount of raw food is being dispensed.

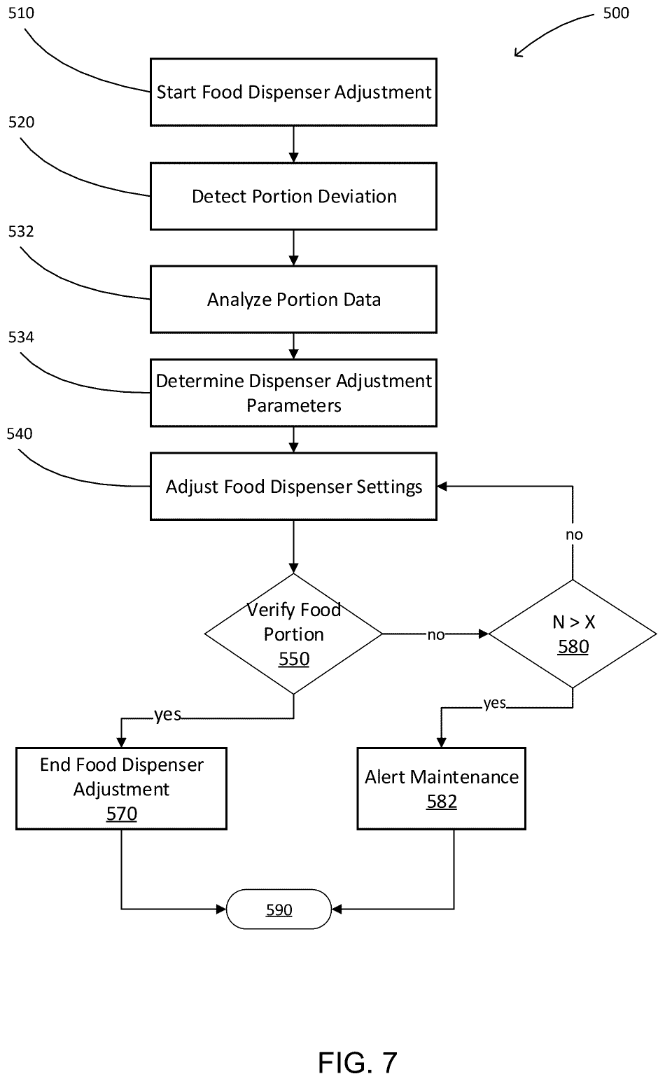

FIG. 7 shows a flow chart of a method 500 for dispensing adjustment of the robotic food preparation system in accordance with an embodiment of the invention.

Step 510 commences the process. In embodiments, a user manually begins the process using a computing device such as a tablet or another user interface. In embodiments, the self-healing process is ongoing and programmed to automatically be performed in real-time, continuously or periodically, e.g., hourly, daily, weekly, etc. In embodiments, the self-healing process is ongoing and perpetually running in parallel with normal operations of the robotic system.

Step 520 states to detect portion deviation. In embodiments, a scale inside the dispenser measures the weight of the dispensed portion.

If the collected data falls within acceptable or normal threshold ranges, the process assumes the portion is acceptable and that there is little or no deviation. An acceptable mass range is the quantify specified in the recipe, for example. The process continues according to normal operation.

If, on the other hand, the detected portion falls outside of the baseline ranges, the process assumes there is an issue and advances to step 532 to analyze the portion deviation.

Step 532 states to analyze portion data. In embodiments, the system computes difference in mass between the dispensed portion and the anticipated or baseline portion.

Step 534 states to determine dispenser adjustment parameters. An adjustment to the dispenser controls is determined based on the computed difference in mass from step 532. In embodiments, if the deviation is, for example, ¼ pound, the dispenser output (filling mechanism) is adjusted by a pro-rata amount to compensate for the computed weight deviation.

Step 540 states to adjust food dispenser settings. In embodiments, adjustments are made by updating the instructions of the dispenser to provide more or less raw food based on step 534. For example, where the deviation was ¼, the filling mechanism output is adjusted by a 1/4 amount.

Step 550 states to verify portion size. In embodiments, this step is performed by running the component or station, and confirming by the sensor data that the portion deviation is not detected.

If the adjustment from step 550 was successful, the process moves to step 570 to end the dispenser adjustment phase and continue normal operations.

If the adjustment from step 550 was not successful, the process returns to step 540 for further adjustment (namely, re-adjustment). Optionally, the parameter is modified by another 5-10%. Re-adjustment and verification can be repeated up to a fixed number of cycles (e.g., N=5) after which the process moves to step 582, and an alert message is sent to the user or maintenance to manually check the system. An alert message may be delivered via SMS, audio, or displayed on the user interface as the case may be.

Step 590 ends the dispenser adjustment process. In embodiments, the adjustment is ended. However, in embodiments, the detecting is ongoing or continuous with normal operations of the robotic system. This feedback loop ensures consistency in portion sizes despite potential mechanical variations or wear in the dispenser system.

### ELEVATOR MOTOR OPTIMIZATION

With reference to FIGS. 1-3, an elevator station 30 operates on a linear guide or pulley system for lifting raw food from the dispenser to an elevated location above a fry basket held by the robotic arm. In embodiments, the elevator is configured as part of a linear rail/guide system including an electric motor operable to raise and lower a carriage, upon which the raw food bin is mounted. An exemplary linear rail and motor is the NEMA 23 ClearPath-SCSK Model, by Teknic, Inc. (Victor, New York). An example of an elevator station is described in provisional patent application number 63/703,953, filed Oct. 5, 2024, entitled “AUTOMATED FOOD FRYING SYSTEM”, which is incorporated herein by reference in its entirety for all purposes.

The elevator can suffer from wear, misalignments, or obstructions.

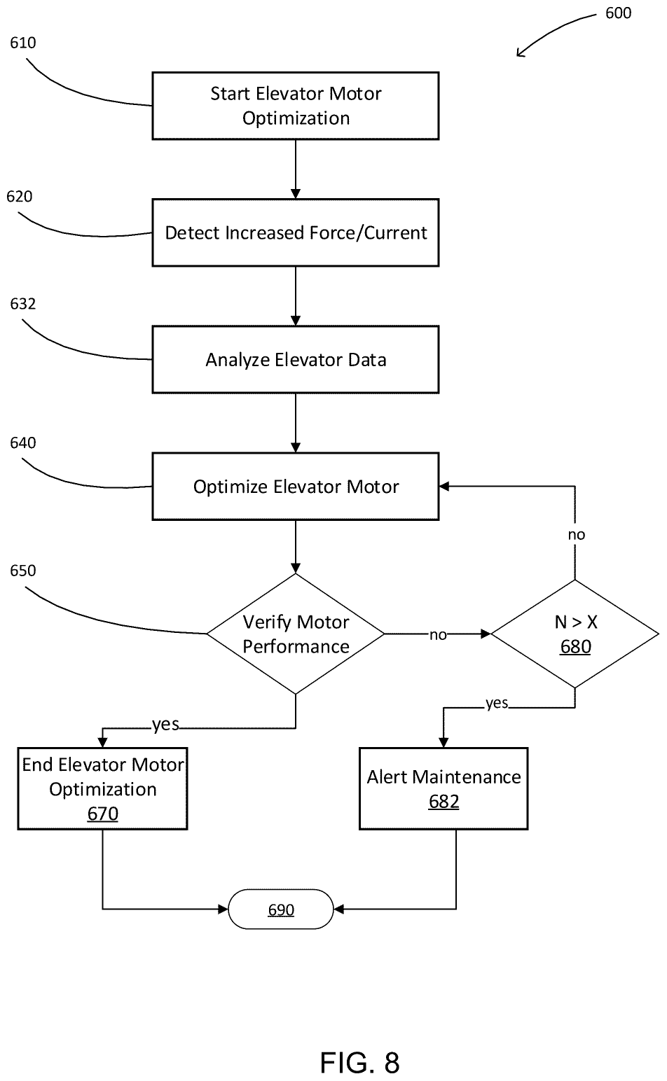

FIG. 8 shows a flow chart of a method 600 for elevator motor health and optimization of the robotic food preparation system in accordance with an embodiment of the invention.

Step 610 commences the process. In embodiments, a user manually begins the process using a computing device such as a tablet or another user interface. In embodiments, the self-healing process is ongoing and programmed to automatically be performed in real-time, continuously or periodically, e.g., hourly, daily, weekly, etc. In embodiments, the self-healing process is ongoing and perpetually running in parallel with operations of the robotic system.

Step 620 states to detect increased force/current. Conditions that lead to increased force or irregular operation can be detected by monitoring changes in the force and power requirement of the elevator motor(s). Baseline values can be established during a fresh installation. Changes in the current readings from the baseline values indicate possible issues with the elevator (e.g., a jam or misalignment).

If the collected data falls within acceptable or normal threshold ranges, the process assumes the elevator motor operation is acceptable and that there is little or no optimization needed. The process continues according to normal operation.

If, on the other hand, the data falls outside of the baseline ranges, the process assumes there is an issue and advances to step 632 to analyze the elevator data.

Step 632 states to analyze elevator data. This step is performed by quantifying the difference between the baseline range and the current offending range. For example, if baseline current readings of the elevator motor are typically within the range of 1.5 to 3.0 Amperes (A), and current activity shows consistent increases to 4.5 A, this indicates potential obstruction or motor strain.

Step 640 states to optimize the elevator motor. In embodiments, the system can optimize the elevator's function by tuning its mechanism to minimize obstructions or strain. This can involve adjusting motor drive parameters such as voltage and current limits based on the deviation observed in step 632, recalibrating the motor operation to prevent jamming by adjusting rotational speed or inertia settings. In embodiments, the motor is tuned/adjusted by the amount computed in step 632.

Step 650 states to verify motor performance. In embodiments, this step is performed by running the component or station, and confirming by the sensor data that offending signal is not detected.

If the adjustment from step 650 was successful, the process moves to step 670 to end the elevator motor tuning phase and continue normal operations.

If the adjustment from step 650 was not successful, the process returns to step 640 for further adjustment (namely, re-adjustment). Optionally, the parameter is modified by another 5-10%. Re-adjustment and verification can be repeated up to a fixed number of cycles (e.g., N=5) after which the process moves to step 682, and an alert message is sent to the user or maintenance to manually check the system. An alert message may be delivered via SMS, audio, or displayed on the user interface as the case may be.

Step 690 ends the optimization process. In embodiments, the optimization process is ended. However, in embodiments, the detecting is ongoing or continuous with normal operations of the robotic food preparation system.

### CAMERA CALIBRATION

As described herein, in embodiments, various cameras are implemented in the robotic food preparation system. For example, in connection with the auto-basket station 50 shown in FIG. 1, at least one camera is positioned within the robotic workspace or enclosure to overlook the auto-basket input area 52. An example of a camera is an RGB camera. In embodiments, the system is programmed and operable to identify the basket and the type of food it contains based on the image data collected from the camera(s).

Additionally, in embodiments, in connection with the fryer station 40 shown in FIG. 3, cameras are located above the fryers (e.g., 42, 44, 46) and optionally equipped with IR LED emitters and a 940nm band-pass filter. The system is programmed and operable to detect basket positions, orientation, and potential misalignments of utensils, equipment, etc., based on these fryer station cameras.

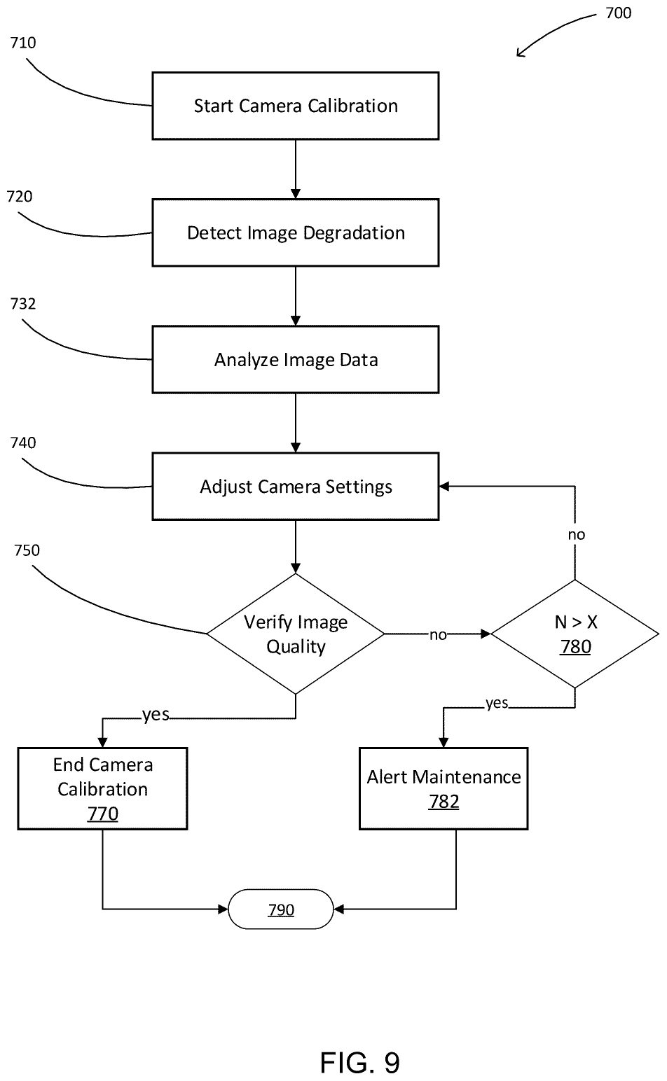

FIG. 9 shows a flow chart of a method 700 for camera calibration of the robotic food preparation system in accordance with an embodiment of the invention.

Step 710 commences the process. In embodiments, a user manually begins the process using a computing device such as a tablet or another user interface. In embodiments, the self-healing process is ongoing and programmed to automatically be performed in real-time, continuously or periodically, e.g., hourly, daily, weekly, etc. In embodiments, the self-healing process is ongoing and perpetually running in parallel with operations of the robotic system.

Step 720 states to detect image degradation. Image degradation can be detected by monitoring for changes in camera shifts, brightness, and increased blur in the images. This may indicate issues such as focus problems, lens obstruction, or sensor degradation.

For example, image brightness is anticipated to maintain a value between 50 and 150 lux in typical operating environments. If real-time measurements fall outside this range, with brightness values below 30 lux or above 180 lux, a degradation is assumed, possibly indicating lens obstruction or incorrect exposure settings.

If the collected data falls within acceptable or normal threshold ranges as determined, e.g., during camera installation, the process assumes the cameras are acceptably calibrated and that there is little or no calibration needed. The process continues according to normal operation.

If, on the other hand, the data falls outside of the baseline ranges, the process assumes there is an issue and advances to step 732 to analyze the image data.

Step 732 states to analyze image data. In this step, a baseline or calibration image is compared to an instant image. For embodiments, a 3D calibration marker and/or image (e.g., a checkered pattern) is mounted in the robotic enclosure and visible by the cameras. The pattern(s) can be used to determine calibration parameters of the camera. Examples of parameters include intrinsic parameters such as the focal length, optical center (principal point), and lens distortion coefficients; extrinsic parameters such as rotation and translation vectors that transform coordinates from the robot space to the camera space; and distortion correction.

Step 740 states to adjust camera settings. This step is performed by adjusting the camera settings based on step 732.

Step 750 states to verify image quality. In embodiments, this step is performed by obtaining another image from the offending camera, and confirming by analyzing the image that the camera an image degradation is not detected. If the adjustment from step 750 was successful, the process moves to step 770 to end the camera calibration phase and continue normal operations.

If the adjustment from step 750 was not successful, the process returns to step 740 for further adjustment (namely, re-adjustment). Optionally, the parameter is modified by another 5-10%. Re-adjustment and verification can be repeated up to a fixed number of cycles (e.g., N=5) after which the process moves to step 782, and an alert message is sent to the user or maintenance to manually check the camera system. An alert message may be delivered via SMS, audio, or displayed on the user interface as the case may be.

Step 790 ends the calibration process. In embodiments, the calibration process is ended. However, in embodiments, the detecting is ongoing or continuous with normal operations of the robotic food preparation system.

### HARDWARE BLOCK DIAGRAM

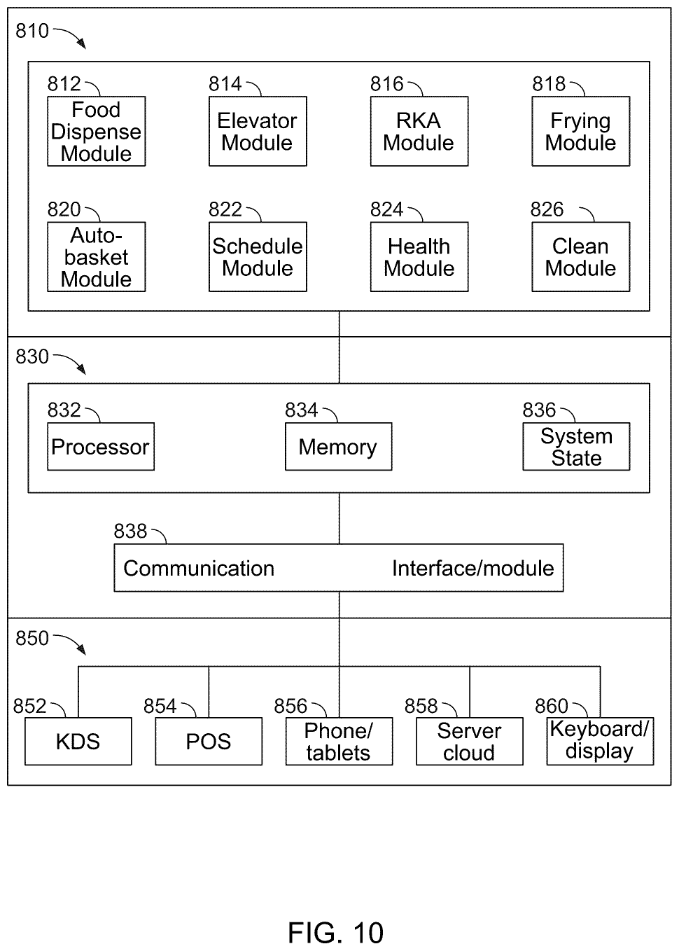

With reference to FIG. 10, a block diagram of a robotic food preparation system 800 includes a plurality of functional modules 810, a computer and electronics 830, and one or more inputs 850.

Examples of functional modules 810 include: raw food dispense module 812, elevator module 814, fryer module 818, robotic arm module 816, auto-basket module 820, Schedule module 822, health (self-healing) module 824, and clean module 826. Each module is shown in communication with the computing system 830. In embodiments, the computing system 830 is operable to keep track of the state, and to provide instructions to each of modules. In embodiments of the invention, each module includes its own hardware and electronics including, e.g., a dedicated controller, motor or actuator, heat exchanger, processor, memory, PCB, integrated chip, and one or more sensors. For embodiments, as described herein, the robotic arm and gripper include internal sensors for measuring current, position, and torque on the arm and gripper. For embodiments, the elevator module includes sensors for measuring current supplied to the elevator motor. For embodiments, the dispenser module includes a scale to measure food delivered from the dispenser.

Optionally, one or more of the modules are self-contained functional units or stations that are conveniently coupled to the computing system 830. For example, in embodiments of the invention, the refrigerated hopper/dispenser 20 and fryer station 40 are self-contained units that are conveniently arranged with the frame 11, and connected electronically to the computer 830 to control the method steps as described above.

The computing device 830 can be a conventional micro-computer and the like including, for example, one or more processors 832, memory or storage devices 834, system state module 836 for keeping track of all events, status, and steps occurring during operation, and communication interface 838. However, the computing device may vary widely and include additional processors, types of memory, ports, communication interfaces (e.g., Wi-Fi, Bluetooth, ethernet, etc.), power supplies, and other components. The computing device 830 can be internal to (or remote from) the food preparation system.

The computing device 830 can be responsive to instructions or requests from a number of input devices 850. Examples of input devices include, without limitation, kitchen display systems (KDS) 852, POS systems 854, tablets and smart phone 856, and onboard touch screens displays 860. Instructions or requests can be entered by an operator, team member, customer, or another as the case may be.

In embodiments, with reference to FIGS. 1-3, the computing and electronics can be arranged in an enclosure 80 towards the rear of the system 10, behind the dispenser station 20, and outside of the framed robotic workspace. In embodiments, the computer and electronics is conveniently accessed by rolling the dispenser unit 20 out of the way.

FIG. 10 also shows server 858 which can be remote or cloud-based. Such remote servers 858 can be used to generally communicate with the system, receive and store data, upload program updates, and host an associated a website. Input devices (e.g., without limitation, tablets, smart phones, desktop or workstations) may download a program or App to conveniently communicate with the website to place an order and monitor activity.

Additionally, a wide variety of sensors can be incorporated with or otherwise used with each of the modules.

For example, a limit switch can sense when the elevator basin is at a first position. The system can be programmed to prohibit the hopper from dispensing food when the limit switch is not in the first position. An example of a suitable limit switch is model XVM3SBQF1802L03, manufactured by CIT Relay and Switch (Rogers, MN).

Photo-presence sensors can be used to monitor for whether an object is present. For example, should the fry basket not be detected, the method proceeds to stop operation until it is replaced. An example of a suitable photo-presence sensor is model WL15-A2430, manufactured by SICK AG, (Waldkirch, Germany).

Load sensors can be used to detect weight. Based on the detected weight, the system can compute whether the proper amount of food has been dispensed into the elevator basin. An example of a suitable load cell is model LCEB, manufactured by Omega Engineering Inc. (Norwalk, CT).

Break beam sensors/reflectors can monitor for a break in the beam. For example, the break beam sensor can monitor if the elevator or auto-baskets are in the first position. An example of a suitable break beam sensor and reflector is model O6S202-O6S-OOKG/AS/3P, manufactured by ifm Efector, Inc. (Malvern, PA 19355).

In embodiments, a safety light curtain for monitoring the ingress window of the auto-drawer is based on use of break beam sensors.

Proximity sensor(s) can monitor for position of the components. For example, one or more proximity sensors may be used to detect the position of the elevator. An example of a suitable proximity sensor is model DW-AD-504-M5, manufactured by Contrinex Gmbh. (Corminboeuf, Switzerland).

In embodiments of the invention, cameras are added and aimed at one or more of the stations. Examples of cameras include RGB and IR cameras. The camera images are sent to the computer processors for determining food item recognition, localization, tracking, food aggregation/clumping, and food doneness. Computer modules for use with the cameras and sensors are described in US Patent Publication No. 20210022559, filed Jul. 25, 2020, entitled “TRANSPORTABLE ROBOTIC-AUTOMATED KITCHEN WORKCELL”, U.S. Pat. No. 10,919,144, filed Aug. 10, 2018, entitled “MULTI-SENSOR ARRAY INCLUDING AN IR CAMERA AS PART OF AN AUTOMATED KITCHEN ASSISTANT SYSTEM FOR RECOGNIZING AND PREPARING FOOD AND RELATED METHODS”, and US Patent Publication No. 20220386807, filed Jun. 1, 2022, entitled “AUTOMATED KITCHEN SYSTEM FOR ASSISTING HUMAN WORKER PREPARE FOOD”, each of which is incorporated herein by reference in its entirety.

### ALTERNATIVE EMBODIMENTS

The invention is intended to include a wide variety of embodiments.

For example, it is to be understood the functional modules may be arranged differently than that shown; some functional units may be removed; and additional functional units (whether serving the same or different purpose) may be added to the system to increase throughput or types of food offerings as desired.

1. An automated food preparation system for cooking raw food comprising:
an enclosure defining a robot workspace;
a robotic arm arranged within the robot workspace;
a plurality of functional stations comprising:
a dispensing station for dispensing raw food into a basin within the enclosure;
a food transfer station comprising the basin and arranged within the enclosure to receive the raw food from the dispensing station, and operable to lift the basin, and to transfer the raw food from the basin to a fry basket held by the robotic arm;
a fry station arranged within the enclosure and comprising at least one fryer for frying the fry basket of raw food into cooked food; and
a computer system programmed to:
control the plurality of functional stations and robotic arm to dispense the raw food to the basin, transfer the raw food to the fry basket, move the fry basket along a route into a fryer, fry the raw food, transfer the cooked food to an egress area for transferring the cooked food from inside the enclosure to outside the enclosure; and
monitor the health of the functional stations and robotic arm by obtaining real-time sensor data obtained from each of the stations during cooking;
analyze the functional stations and robotic arm for an abnormal condition based on comparing the real-time sensor data and baseline sensor data;
compute an adjustment for the functional stations and robotic arm based on the analysis of the functional stations and robotic arm; and
modify the functional station or robotic arm based on the computed adjustment.

2. The system of claim 1, further comprising an auto-drawer station arranged within the enclosure comprising at least one drawer movable from a retracted first configuration within the enclosure to an extended second configuration through an ingress window outside of the enclosure, and wherein the at least one drawer and ingress window are arranged, sized and operable to transfer a fry basket between a human outside of the enclosure and the robotic arm inside of the enclosure without the human or robotic arm penetrating a boundary defined by the enclosure.

3. The system of claim 1, wherein the sensor data comprises at least one of robotic arm torque, robotic arm position, elevator motor current, camera parameters, and the weight of the raw food dispensed into the basin.

4. The system of claim 1, wherein the food transfer station comprises an elevator to move the basin between a first elevation for receiving the raw food from the dispensing station to a second elevation higher than the first elevation for dumping the raw food into the fry basket.

5. The system of claim 4, wherein the real-time sensor data comprises current data of a motor for moving the elevator, and the current for the elevator is modified.

6. The system of claim 1, wherein the real-time sensor data comprises weight data of the raw food dispensed into the basin by the dispenser, and the dispensing controls are modified.

7. The system of claim 1, wherein the real-time sensor data comprises torque data of the robotic arm, and the route of the robotic arm is modified.

8. The system of claim 1, wherein the real-time sensor data comprises position data of the robotic arm, and the route of the robotic arm is modified.

9. The system of claim 1, wherein the real-time sensor data comprises image data for a camera, and camera parameters are modified.

10. The system of claim 1, wherein the computer system is programmed to verify the abnormal condition is absent during cooking after the modification has been made.

11. A method for automatically preparing raw food comprising:
automatically dispensing a target amount of raw food into a basin;
lifting by a motor-driven elevator the basin of raw food above a fry basket;
dumping the raw food from the basin into the fry basket;
robotically moving the fry basket along a predetermined route into a fryer;
cooking the raw food in the fryer;
robotically transferring the cooked food to an egress area for transferring the cooked food from inside the enclosure to outside the enclosure; and
continuously obtaining real-time sensor data during each of the dispensing, lifting, robotically moving, and robotically transferring steps;
analyzing each step for an abnormal condition based on comparing the real-time sensor data and baseline sensor data;
and if one of said steps has an abnormal condition, then computing an adjustment to the step having the abnormal condition based on the analyzing step; and
modifying the step having the abnormal condition based on the computed adjustment.

12. The method of claim 1, wherein the real-time sensor data comprises at least one of robotic arm torque, robotic arm position, elevator motor current, camera parameters, and the weight of the raw food dispensed into the basin.

13. The method of claim 12, wherein the real-time sensor data comprises current data of a motor for moving the elevator, and the current for the elevator is modified.

14. The method of claim 12, wherein the real-time sensor data comprises weight data of the raw food dispensed into the basin by the dispenser, and the dispensing controls are modified.

15. The method of claim 12, wherein the real-time sensor data comprises torque data of the robotic arm, and the route of the robotic arm is modified.

16. The method of claim 12, wherein the real-time sensor data comprises position data of the robotic arm, and the route of the robotic arm is modified.

17. The method of claim 12, wherein the real-time sensor data comprises image data for a camera, and camera parameters are modified.

18. The method of claim 11, further comprising verifying the abnormal condition is absent during cooking after the modification has been made.
